(19) United States
(12) Patent Application Publication
(10) Pub. No.: US 2005/0125819 A1
(43) Pub. Date: Jun. 9, 2005

(54) Broadcast receiving apparatus, control method and program therefor

(75) Inventors: Kenichiro Ono, Kanagawa (JP); Hideaki Yui, Kanagawa (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/994,340

(22) Filed: Nov. 23, 2004

(30) Foreign Application Priority Data
Dec. 9, 2003 (JP) 2003-410610

(51) Int. Cl. H04H 9/00; H04N 7/16

(52) U.S. Cl. 725/14; 725/9; 725/12; 725/15

(57) ABSTRACT

The invention provides a broadcast reception apparatus allowing, when a reception status is worsened in a child device, to automatically view the broadcast program that has been viewed in the child device, in continuation in a parent device.

A parent/child television system include an antenna 1, a parent device A100, a child device B200 capable of wireless communication with the parent device A100, and a remote control 33. When a broadcasting is viewed in the child device B200 utilizing a digital tuner B12 of the parent device A100, a CPU-B58 of the child device B200 watches the reception state of the child device B200, and in case a transmission error is found frequently and another digital tuner A2 of the parent device A100 is not in use, a CPU-A 38 of the parent device A100 terminates transmission of a transport stream data to the child device B200 and sets the digital tuner A2, a video decoder A6 and an audio decoder A7 in a state where broadcast program can be viewed in the parent device A100.

### BACKGROUND OF THE INVENTION

1. Field of the Invention

The present invention relates to a broadcast receiving apparatus, a control method and a program therefor, applicable to a television receiver of a configuration, separated into a receiving portion for receiving a television broadcast wave and a display portion for displaying an image of the television broadcasting in which both portions are connected by a wireless or wired link and including a recording apparatus in the receiving portion.

2. Related Background Art

In order to meet a requirement of enjoying television viewing in an arbitrary location without being restricted by an antenna cable, there is proposed a technology, for a television receiver provided with a receiving portion connected to an antenna for receiving a television broadcast wave and a display portion for displaying an image of the television broadcasting, of transmitting signals between the receiving portion and the display portion by a wireless link (for example patent reference 1).
Patent reference 1: Japanese Patent Application Laid-Open No. 2001-358966 (US AA 2002059585)

However, such prior technology does not have measures against a failure in the wireless transmission between the receiving portion and the display portion of the television receiver, or against a battery capacity deficiency in case the display portion is driven by a battery. Also in a configuration including, in the receiving portion, a recording portion for recording a broadcast program, the broadcast program can no longer be viewed in case of a failure in the display portion though the program can be recorded in the recording portion.

### SUMMARY OF THE INVENTION

An object of the present invention is to provide a broadcast receiving apparatus, a control method and a program, which allow, in case of a deterioration in a reception state of a child device, to view a broadcast program, that has been viewed in the child device, automatically and in continuation in a parent device.

For attaining the aforementioned object, the present invention is characterized by a broadcast receiver including a parent device capable of receiving a broadcast wave and displaying a broadcast program and a child device constructed communicably with the parent device and capable of displaying a broadcast program based on broadcast data transmitted from the parent device, wherein the child device includes watching means which watches a reception status of the child device, and the parent device includes control means which, in response to a notice from the child device for a worsened reception state, enables the parent device to display a broadcast program that has been displayed on the child device.

The present invention is also characterized by a broadcast receiver including a parent device capable of receiving a broadcast wave and displaying a broadcast program and a child device constructed communicably with the parent device and capable of displaying a broadcast program based on broadcast data transmitted from the parent device, wherein the child device includes watching means which watches a remainder charge of a battery for driving the child device and the parent device includes control means which, in response to a notice from the child device for a remainder charge of the battery less than a set value, enables the parent device to display a broadcast program that has been displayed on the child device.

The present invention is also characterized by a broadcast receiver including a parent device capable of receiving a broadcast wave and displaying a broadcast program and a child device constructed communicably with the parent device and capable of displaying a broadcast program based on broadcast data transmitted from the parent device, wherein the child device includes watching means which watches a reception status of the child device and a remainder charge of a battery for driving the child device, and the parent device includes control means which, in response to a notice from the child device for a worsened reception state or a remainder charge of the battery less than a set value, enables the parent device to record a broadcast program that has been displayed on the child device.

The present invention is also characterized by a broadcast receiver including a parent device capable of receiving a broadcast wave and displaying a broadcast program and a child device constructed communicably with the parent device and capable of displaying a broadcast program based on broadcast data transmitted from the parent device, wherein the child device includes informing means which periodically transmits a status information indicating a normal reception during the display of the broadcast program on the child device, and the parent device includes control means which, in response to an interruption of the status information from the child device, enables the parent device to record the broadcast program that has been displayed on the child device.

Furthermore, the present invention may adopt a configuration in which, in case of a worsened reception status of the child device, a user can select either to display the broadcast program that has been displayed in the child device, in the parent device, or to record the broadcast program that has been displayed in the child device, in the parent device.

Furthermore, the present invention may adopt a configuration in which, in case a remainder charge of a battery of the child device becomes less than a set value, the user can select either to display the broadcast program that has been displayed in the child device, in the parent device, or to record the broadcast program that has been displayed in the child device, in the parent device.

Furthermore, the present invention may adopt a configuration in which, in case of a worsened reception status of the child device or in case a remainder charge of a battery of the child device becomes less than a set value, the user can select either to record the broadcast program that has been displayed in the child device, in the parent device or to display the broadcast program that has been displayed in the child device, in the parent device.

Furthermore, the present invention may adopt a configuration in which, in case a status information indicating a normal reception is not transmitted from the child device to the parent device, the user can select either to record the broadcast program that has been displayed in the child device, in the parent device or to display the broadcast program that has been displayed in the child device, in the parent device.

Thus in the present invention, as a reception status is watched during a display of a broadcast program in the child device and the parent device, in response to a notice from the child device for a worsened reception state, displays the broadcast program that has been displayed on the child device, there is provided an effect that the user can automatically continue to view the broadcast program, which has been viewed in the child device, in the parent device.

Also in the present invention, as the parent device, in response to a notice from the child device for a worsened reception state, terminates a transmission of broadcast data to the child device and displays the broadcast program that has been displayed on the child device, in the parent device in case a continued viewing is desired, there is provided an effect that the user can automatically continue to view the broadcast program, which has been viewed in the child device, in the parent device.

Also in the present invention, as a remainder charge of a battery for driving the child device is watched during a display of a broadcast program in the child device and the parent device, in response to a notice from the child device for a remainder charge of the battery less than a set value, displays on the parent device the broadcast program that has been displayed on the child device, there is provided an effect that the user can automatically continue to view the broadcast program, which has been viewed in the child device, in the parent device.

Also in the present invention, as the parent device, in response to a notice from the child device for a remainder charge of the battery less than a set value, terminates a transmission of broadcast data to the child device and displays the broadcast program that has been displayed on the child device, in the parent device in case a continued viewing is desired, there is provided an effect that the user can automatically continue to view the broadcast program, which has been viewed in the child device, in the parent device.

Also in the present invention, as a reception status of the child device and a remainder charge of a battery for driving the child device are watched during a display of a broadcast program in the child device and, in case the parent device receives a notice from the child device for a worsened reception state or a remainder charge of the battery less than a set value, the broadcast program that has been displayed in the child device is recorded in the parent device, there is provided an effect that the user can automatically record, in the parent device, the broadcast program which has been viewed in the child device.

Also in the present invention, in case the worsened reception state or the remainder charge of the battery less than a set value in the child device is resolved, the parent device informs the child device that the broadcast program recorded in the patent device can be reproduced in the child device, so that there is provided an effect that the user can view a continuation of the broadcast program, which the user has interrupted to view, can be reproduced and viewed in the child device.

Also in the present invention, as a status information indicating a normal reception during a display of a broadcast program on the child device is periodically transmitted from the child device to the parent device and the parent device, in case of an interruption of the status information from the child device, enables the parent device to record the broadcast program that has been displayed on the child device, there is provided an effect that the broadcast program that has been displayed in the child device can be automatically recorded in the parent device.

Also in the present invention, in case the status information is sent again from the child device to the parent device, control means of the parent device informs the child device that the broadcast program recorded in the patent device can be reproduced in the child device, so that there is provided an effect that the user can view a continuation of the broadcast program, which the user has interrupted to view, can be reproduced and viewed in the child device.

### BRIEF DESCRIPTION OF THE DRAWINGS

FIG. 1 is a block diagram showing a configuration of a parent/child television system constituting a first embodiment of the present invention;

FIG. 2 is a flow chart showing operations in case a reception status is worsened in the parent/child television system;

FIG. 3 is a continuation of the flow chart shown in FIG. 2;

FIG. 4 is a block diagram showing a configuration of a parent/child television system constituting a second embodiment of the present invention;

FIG. 5 is a flow chart showing operations in case a remainder charge in a battery is lowered in the parent/child television system;

FIG. 6 is a continuation of the flow chart shown in FIG. 5;

FIG. 7 is comprised of FIGS. 7A and 7B showing block diagrams of a configuration of a parent/child television system constituting a third embodiment of the present invention;

FIG. 8 is a flow chart showing operations in case a reception status is worsened or a remainder charge in a battery is lowered in the parent/child television system;

FIG. 9 is a continuation of the flow chart shown in FIG. 8;

FIG. 10 is a continuation of the flow chart shown in FIG. 9;

FIG. 11 is a continuation of the flow chart shown in FIG. 10;

FIG. 12 is a continuation of the flow chart shown in FIG. 11;

FIG. 13 is a view showing an example of a menu image prepared by an OSD processor of the parent device; and

FIG. 14 is a flow chart showing operations of a parent/child television system constituting a fourth embodiment of the present invention;

FIG. 15 is a continuation of the flow chart shown in FIG. 14; and

FIG. 16 is a continuation of the flow chart shown in FIG. 15.

### DETAILED DESCRIPTION OF THE PREFERRED EMBODIMENTS

In the following the present invention will be clarified in details by embodiments thereof, with reference to the accompanying drawings.

### First Embodiment

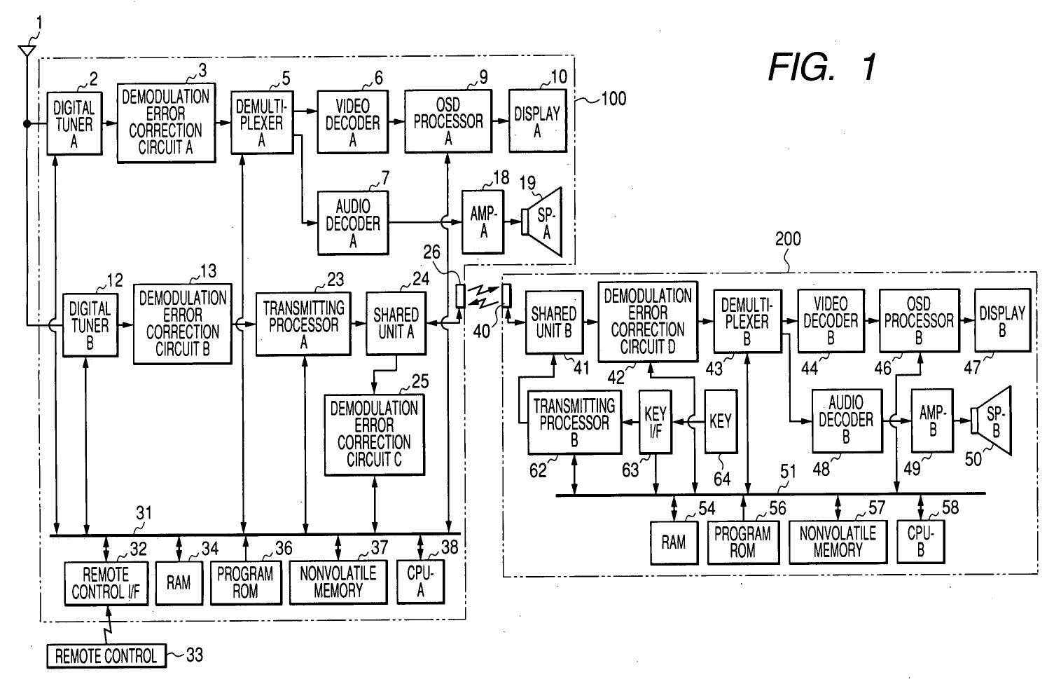

FIG. 1 is a block diagram showing a configuration of a parent/child television system constituting a first embodiment of the present invention.

Referring to FIG. 1, a parent/child television system is provided with an antenna 1 for receiving a digital broadcast wave transmitted from a broadcasting station, a parent device A100 for executing a video display and an audio reproduction based on the digital broadcast wave received by the antenna 1, a child device B200 for executing a video display and an audio reproduction based on a transport stream data outputted from the parent device A100, and a remote control 33 for various instructions to the parent/child television system by a user.

In the present embodiment, a digital broadcasting receivable by the parent/child television system is based on a digital broadcasting system standards of DVB (digital video broadcasting), in which a video signal and an audio signal are respectively transmitted from the broadcasting station according to an MPEG2 (Moving Picture Experts Group 2) standard of ISO/IEC (International Organization for Standardization/International Electrotechnical Commission) 61818-2 and an MPEG2 standard of ISO/IEC 61818-3.

The present embodiment explains a case of satellite broadcasting as an example of the digital broadcasting to be received by the parent/child television system from the broadcasting station, but the present invention is not limited to such satellite broadcasting but is applicable to a case of receiving a cable television broadcasting through a coaxial cable or an optical fiber cable, or a case of receiving a broadband broadcasting through a broadband network.

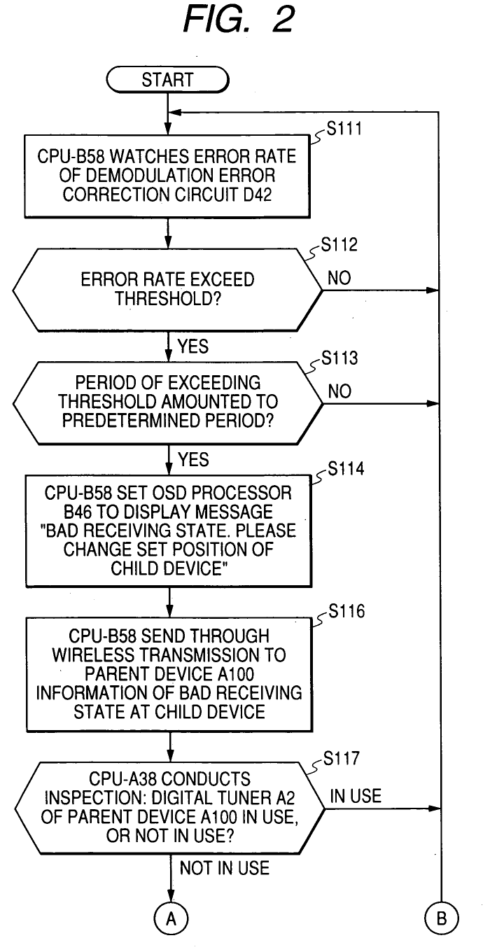

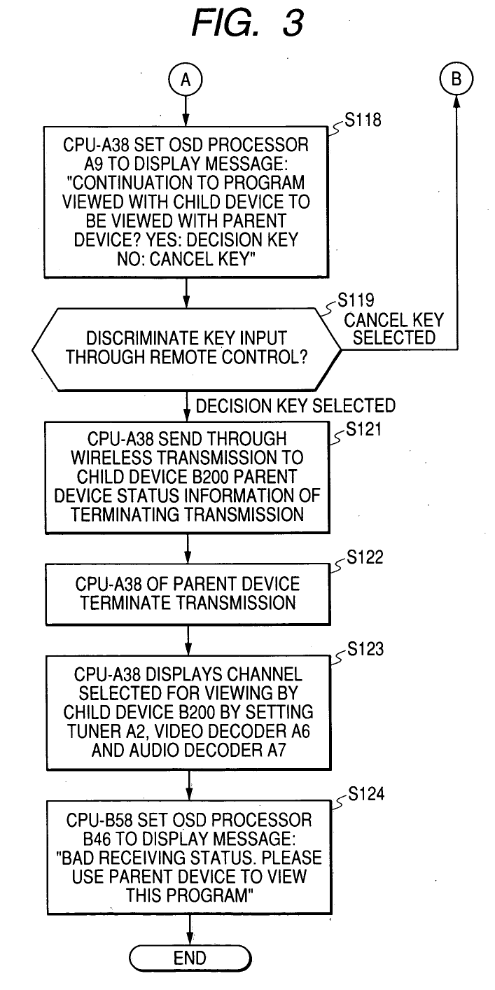

At first there will be explained a configuration of the parent device A100. The parent device A100 is capable of a wireless communication with a child device B200 to be explained later. A digital tuner A2 and a digital tuner B12 of the parent device A100 are respectively connected to the antenna 1. The antenna 1 is used for receiving a digital broadcast wave. A CPU-A (control means) 38 controls various units of the parent device A100 according to a program, and executes a process of the parent device side in flow charts shown in FIGS. 2 and 3. A program ROM 36 stores the aforementioned program.

A common bus 31 constitutes a signal transmission path for connecting the CPU-A 38 and various units. The common bus 31 is connected, in addition to the CPU-A 38 and the program ROM 36, to a remote control interface 32 for receiving an infrared code of the remote control 33 and transmitting it to the CPU-A 38, a RAM 34 constituting a work memory of the CPU-A 38, and a non-volatile memory 37 for memorizing information that should not be erased, such as information of a broadcasting channel that has been selected immediately before the power supply of the present television system is turned off. The remote control 33 is provided with a decision key, a decision cancel key, a cursor key (foregoing keys not shown) etc. to be explained later.

The digital tuner A2 and the digital tuner B12 respectively select desired frequencies according to an instruction of the CPU-A 38 from the broadcast waves received by the antenna 1. Signals outputted from the digital tuner A2 and the digital tuner B12 are subjected to a demodulation and an error correction respectively by a demodulation/error correction circuit A3 and a demodulation/error correction circuit B13 and outputted as transport streams.

The transport stream data outputted from the demodulation/error correction circuit A3 are supplied to a demultiplexer A5. The demultiplexer A5 selects, from the multiplexed stream, a stream having a PID (packet identifier) designated by the CPU-A 38, and sends a video stream to a video decoder A6 and an audio stream to an audio decoder A7. Further the demultiplexer A5 also selects information on time and broadcast program content, called SI (system information) contained in the transport stream and transfers it to the CPU-A 38.

The video stream is decoded by the video decoder A6 into a non-compressed video data, thereby providing an image. An OSD (on screen display) processor A9, executing a video signal processing for displaying various messages according to data supplied from the CPU-A 38, is so-called text/graphics process circuit for displaying information such as a character, a picture or a symbol other than the image of the broadcast program. In case of displaying a message, information for displaying a message is supplied from the CPU-A 38 to the OSD processor A9, which synthesizes the message display information with the video signal from the video decoder A6. The synthesized image is displayed on a display A10.

Also the audio stream supplied from the demultiplexer A5 to the audio decoder A7 is decoded by the audio decoder A7 into a non-compressed audio data, which are outputted, after amplified by an amplifier A18, as a voice from a speaker A19.

On the other hand, the transport stream data outputted from the demodulation/error correction circuit B13 are supplied to a transmission processor A23, which, according to a control signal from the CPU-A 38, executes a transmission rate modulation and an amplification of a transmission signal to the child device B200. The transmission signal processed in the transmission processor A23 is wireless transmitted through a shared device A24 and a transmission/reception antenna 26 to the child device B200.

The shared device A24 prevents an interference between a transmission signal to the child device B200 and a reception signal from the child device B200. A parent device status, indicating a state of the parent device A100 is also sent, when necessary, from the CPU-A 38 to the transmission processor A23 and can be transmitted as parent device status information to the child device B200 through the shared device A24 and the transmission/reception antenna 26.

A wireless signal transmitted from the child device B200 to the parent device A100 is received by wireless through the transmission/reception antenna 26 and the shared device A24, then subjected to a demodulation and an error correction by a demodulation/error correction circuit C25 and transmitted as key information or child status information from the child device B200 to the CPU-A 38.

In the following, the configuration of the child device B200 will be explained. The child device B200 is constructed as a portable device provided with a thin and light display such as a liquid crystal display, and can be installed in any location without requiring a connection with an external antenna, within a range capable of wireless communication with the parent device A100. A CPU-B 58 (watching means) controls various units of the child device B200 according to a program, and executes a process of the child device side in the flow charts shown in FIGS. 2 and 3. A program ROM 56 stores the aforementioned program.

A common bus 51 constitutes a signal transmission path for connecting the CPU-B 58 and various units. The common bus 51 is connected, in addition to the CPU-B 58 and the program ROM 56, to a RAM 54 constituting a work memory of the CPU-B 58, and a non-volatile memory 57 for memorizing information that should not be erased, such as information of a broadcasting channel that has been selected immediately before the power supply of the present television system is turned off.

Wireless transport stream data transmitted from the parent device A100 to the child device B200 is received by wireless through a transmission/reception antenna 40 and a shared device B41, then subjected to a demodulation and an error correction by a demodulation/error correction circuit D42, thus being demodulated into transport stream data, and further supplied to a demultiplexer B43. The demultiplexer B43 selects, from the multiplexed stream, a stream having a PID designated by the CPU-B 58, and sends a video stream to a video decoder B44 and an audio stream to an audio decoder B48.

The video stream is decoded by the video decoder B44 into a non-compressed video data, thereby providing an image. An OSD processor B46, executing a video signal processing for displaying various messages according to data supplied from the CPU-A 38, is so-called text/graphics process circuit for displaying information such as a character, a picture or a symbol other than the image of the broadcast program. In case of displaying a message, information for displaying a message is supplied from the CPU-B 58 to the OSD processor B46, which synthesizes the message display information with the video signal from the video decoder B44. The synthesized image is displayed on a display B47, such as a liquid crystal display.

Also the audio stream supplied from the demultiplexer B43 to the audio decoder B48 is decoded by the audio decoder B48 into a non-compressed audio data, which are amplified by an amplifier B49 and outputted as a voice from a speaker B50.

The child device B200 receives, in addition to the wireless transport stream data from the parent device A100, parent device status information, transmitted by wireless communication, through the transmission/reception antenna 40 and the shared device B41, then subjected to a demodulation and an error correction by the demodulation/error correction circuit D42 to generate parent device status information which is transmitted to the CPU-B 58.

Keys 64 is constituted of channel up/down keys for selecting a channel of the received digital broadcasting, volume up/down keys for regulating a sound volume of the received digital broadcasting, and a power key for turning on/off the power supply of the child device B200 (these keys not shown). When the volume up key, the volume down key or the child device power key is depressed by the user, as the present television system is so constructed as to execute processes corresponding to these key operations within the child device B200, a key interface 63 transmits a code corresponding to a key to the CPU-B58, which thus executes an operation corresponding to the depressed key (volume up/down, power supply on/off).

On the other hand, when the channel up key or the channel down key is depressed by the user, since the present television system is so constructed that the channel up/down information has to be informed from the child device B200 to the parent device A100, the key interface 63 transmits a code corresponding to a key to a transmission processor B52, which executes a transmission rate modulation process or an amplification process according to a control signal from the CPU-B 58.

Also a transmission signal processed in the transmission processor B52 is transmitted by wireless as key information, through the shared device B41 and the transmission/reception antenna 40, to the parent device A100. A child device status, indicating a state of the child device B200 is also sent, when necessary, from the CPU-B 58 to the transmission processor B52 and is transmitted as child device status information to the parent device A100 through the shared device B41 and the transmission/reception antenna 40.

The parent device A100 receives the information from the child device B200 by wireless and through the transmission/reception antenna 26 and the shared device A24, and the information is then subjected to a demodulation and an error correction by the demodulation/error correction circuit C25 and transmitted as key information or child status information from the child device B200 to the CPU-A 38. The CPU-A 38 issues an instruction, based on the key information corresponding to the depression of the channel up key or the channel down key in the child device B200, to the digital tuner B12 for a change to a desired frequency. When the broadcast channel is changed by a frequency change in the digital tuner B12, corresponding transport stream data are supplied from the parent device A100 to the child device B200 and are decoded as explained in the foregoing.

In the following there will be explained, with reference to flow charts shown in FIGS. 2 and 3, operations when a reception state becomes worse while the user enjoys, in the parent/child television system of the present embodiment, a digital broadcasting in the child device B200 by receiving transport stream data utilizing the digital tuner B12 of the parent device A100.

Referring to FIGS. 2 and 3, the demodulation/error correction circuit D42 of the child device B200 constantly measures an error rate in the transport stream data received from the patent device A100, and the CPU-B 58 of the child device B200 constantly watches the measured error rate (step S111). When the error rate exceeds a certain value, the demodulation/error correction circuit D42 becomes incapable of error correction, whereby the video decoder B44 or the audio decoder B48 cannot execute a proper decoding process. Since the child device B200 is movable as mentioned above, the reception state may change by a displacement of the child device B200 during the reception of the broadcasting.

When the CPU-B58 of the child device B200, watching the error rate measured by the demodulation/error correction circuit D42 judges that the error rate has exceeded a certain value (threshold value) (step S112), and when a state where the error rate exceeds the certain value continues for a predetermined period, a proper decoding is judged impossible (step S113), whereupon the sequence proceeds to a step S114.

The CPU-B 58 of the child device B200 instructs a display control (video signal process) for a message “BAD RECEIVING STATE, PLEASE CHANGE SET POSITION OF CHILD DEVICE” to the OSD processor B46, thereby displaying such message on the display B47 (step S114), thus requesting a movement to a location of a better reception state to the user. Also the CPU-B 58 of the child device B200 wireless transmits child status information indicating a bad reception state to the patent device A100 (step S116).

Then, the CPU-A 38 of the parent device A100, in case the reception state is not improved, gives up the viewing by the user on the child device B200 and executes a preparation for switching to a viewing by the user on the parent device A100. The CPU-A 38 of the parent device A100 checks whether the digital tuner A2 is in use (step S117). If the digital tuner A2 is in use, the sequence returns to the step S111, but, if the digital tuner A2 is not in use, the sequence proceeds to a step S118.

The CPU-A 38 of the parent device A100 instructs a display control (video signal process) for a message “CONTINUATION OF PROGRAM VIEWED WITH CHILD DEVICE TO BE VIEWED WITH PARENT DEVICE? YES: DECISION KEY, NO: CANCEL KEY” to the OSD processor A9, thereby displaying such message on the display A10 (step S118), thus requesting, to the user, a judgment whether to continue viewing, on the parent device A100, of the broadcast program which has been viewed with the child device B200.

Then the CPU-A 38 of the parent device A100 discriminates the depressed key of the remote control 33 through the remote control interface 32. In case the user depresses the decision cancel key (not shown), it is judged that the viewing is not continued in the parent device A100 and the sequence returns to the step S111. In case the user depresses the decision key not shown), it is judged that the viewing is continued in the parent device A100 and the sequence proceeds to a step S111.

In case the user depresses the decision key, the CPU-A 38 of the parent device A100 executes a wireless transmission of parent device status information, indicating a termination of the transmission from the parent device A100 to the child device B200, to the child device B200 (step S121), and terminates the transmission of the transport stream data to the child device B200 (step S122). Also, CPU-A 38 of the parent device A100, already knowing the broadcast channel (broadcast program) that has been viewed by the child device B200, sets the digital tuner A2, the video decoder A6 and the audio decoder A7 in a state capable of viewing the broadcast program in the parent device A100, and displays the broadcast channel (broadcast program), that has been viewed by the child device B200, on the display A10 (step S123), whereby a continued viewing on the parent device A100 becomes possible.

On the other hand, the CPU-B 58 of the child device B200 instructs a display control (video signal process) for a message “BAD RECEIVING STATUS. PLEASE USE PATENT DEVICE TO VIEW THIS PROGRAM” to the OSD processor B46, thereby displaying such message on the display B47 (step S124), thus requesting a viewing on the parent device A100 to the user.

In the present embodiment, as explained in the foregoing, while the user views a digital broadcasting in the child device B200 utilizing the digital tuner B12 of the parent device A100, the CPU-B 58 of the child device B200 watches the receiving status of the child device B200 (error rate of the transport stream data received from the patent device A100), and, in case the receiving status becomes worse and the other digital tuner A2 of the parent device A100 is not in use, the CPU-A 38 of the parent device A100 terminates the transmission of the transport stream data to the child device B200 and sets the digital tuner A2, the video decoder A6 and the audio decoder A7 in a state capable of viewing the broadcast program in the parent device A100, whereby the user can automatically view, in continuation in the parent device A100, the broadcast program that has been viewed in the child device B200.

### Second Embodiment

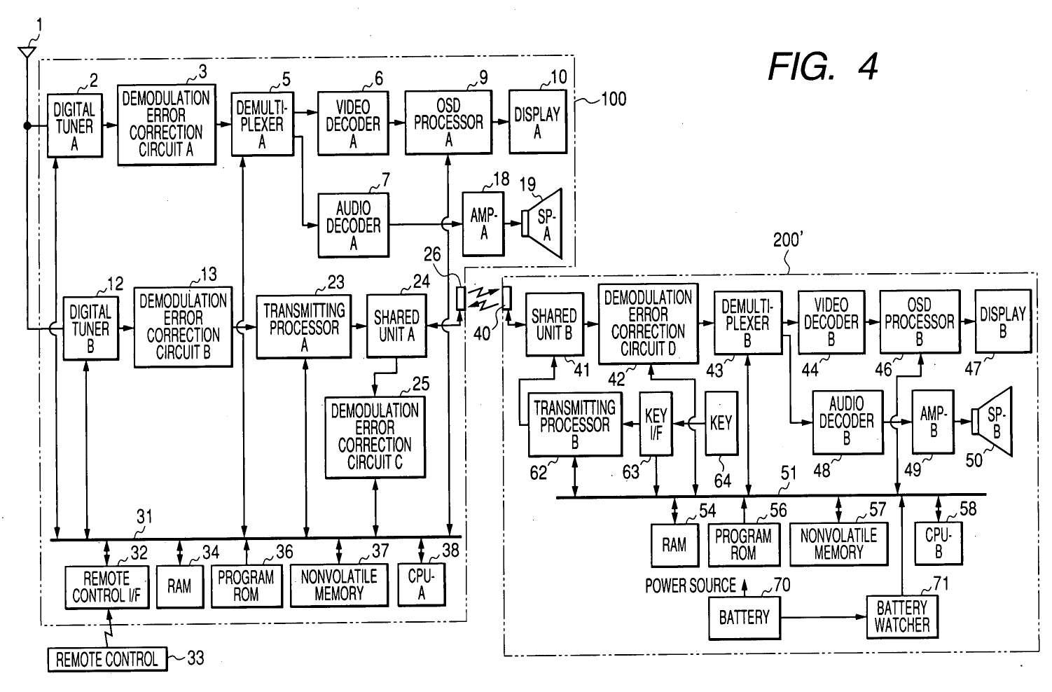

FIG. 4 is a block diagram showing a configuration of a parent/child television system constituting a second embodiment of the present invention.

The present embodiment is different from the foregoing first embodiment in that the child device B200 is provided with a battery 70 and battery watching means 71 (watching means). Other components of the present embodiment are similar to those in the first embodiment (FIG. 1), thus represented by corresponding numbers and are not explained further.

At first, there will be explained differences of the present embodiment from the first embodiment. The child device B200 is battery drivable, and is rendered more widely movable by utilizing the battery 70 as a power source for the entire child device. A remainder charge of the battery 70 is constantly watched by the battery watching unit 71, and is made available to the CPU-B 58 of the child device B200.

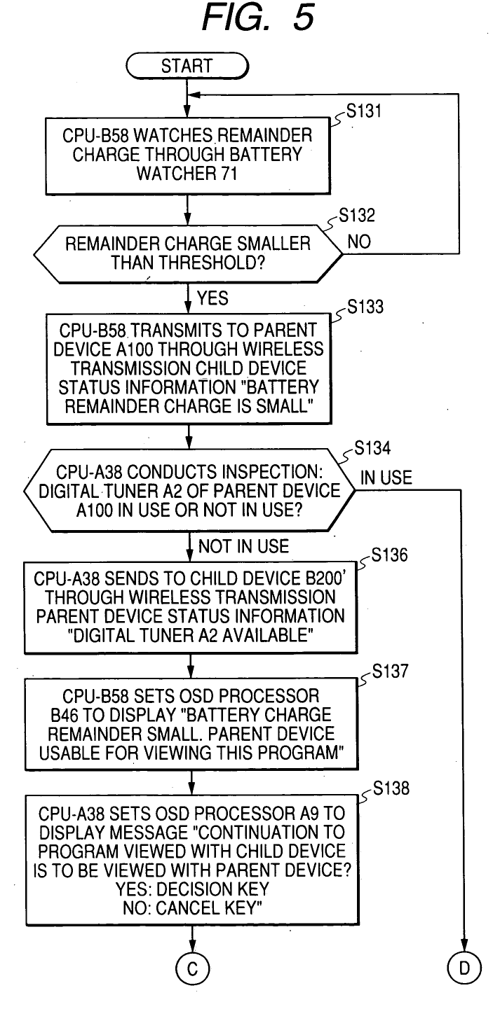

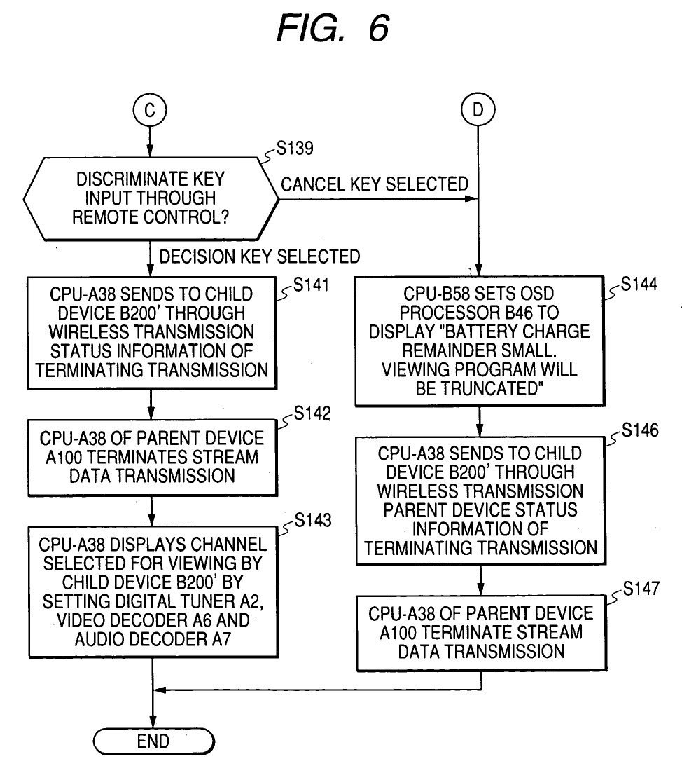

The CPU-A 38 of the parent device A100 executes a process of a parent device side according to a program, in the flow charts shown in FIGS. 5 and 6, and the CPU-B 58 of the child device B200 executes a process of a child device side according to a program, in the flow charts shown in FIGS. 5 and 6.

In the following there will be explained, with reference to flow charts shown in FIGS. 5 and 6, operations when a remainder charge of the battery becomes low while the user enjoys, in the parent/child television system of the present embodiment, a digital broadcasting in the child device B200 by receiving transport stream data utilizing the digital tuner B12 of the parent device A100.

Referring to FIGS. 5 and 6, the CPU-B 58 of the child device B200 watches a battery remainder charge watched by a battery watching unit 71 (step S131), and when the battery remainder charge is less than a limit for executing decoding processes in the video decoder B44 and the audio decoder B48 and for display in the display B47 (step S132), it transmits, by a wireless transmission, child device status information indicating a low battery remainder charge to the parent device A100 (step S133).

Then, the CPU-A 38 of the parent device A100 gives up the viewing by the user on the child device B200 and executes a preparation for switching to a viewing on the parent device A100. The CPU-A 38 of the parent device A100 checks whether the digital tuner A2 is in use (step S134). If the digital tuner A2 is in use, the sequence proceeds to a step S144, but, if the digital tuner A2 is not in use, the sequence proceeds to a step S36. In case the digital tuner A2 is not in use, the CPU-A 38 of the parent device A100 executes a wireless transmission of parent device status information indicating that the digital tuner A2 is usable, to the child device B200 (step S136).

In response, the CPU-B 58 of the child device B200 instructs a display control (video signal process) for a message “BATTERY REMAINDER CHARGE SMALL. PARENT DEVICE USABLE FOR VIEWING THIS PROGRAM” to the OSD processor B46, thereby displaying such message on the display B47 (step S137), thus requesting, to the user, a viewing on the parent device A100.

As the user is expected to come in front of the parent device A100 in response to the message displayed on the display B47, the CPU-A 38 of the patent device A100 instructs a display control (video signal process.) for a message “CONTINUATION OF PROGRAM VIEWED WITH CHILD DEVICE TO BE VIEWED WITH PARENT DEVICE? YES: DECISION KEY, NO: CANCEL KEY” to the OSD processor A9, thereby displaying such message on the display A10 (step S138), thus requesting, to the user, a judgment whether to continue viewing, on the parent device A100, of the broadcast program which has been viewed with the child device B200.

Then the CPU-A 38 of the parent device A100 discriminates the depressed key of the remote control 33 through the remote control interface 32 (step S139). In case the user depresses the decision cancel key, it is judged that the viewing is not continued in the parent device A100 and the sequence proceeds to a step S144. In case the user depresses the decision key, it is judged that the viewing is continued in the parent device A100 and the sequence proceeds to a step S141.

In case the user depresses the decision key, the CPU-A 38 of the parent device A100 executes a wireless transmission of parent device status information, indicating a termination of the transmission from the parent device A100 to the child device B200, to the child device B200 (step S141), and terminates the transmission of the transport stream data to the child device B200 (step S142). Also, CPU-A 38 of the parent device A100 sets the digital tuner A2, the video decoder A6 and the audio decoder A7 in a state capable of viewing the broadcast program in the parent device A100, and displays the broadcast channel (broadcast program), that has been viewed by the child device B200, on the display A10 (step S143), whereby a continued viewing on the parent device A100 becomes possible.

On the other hand, when the user depresses the decision cancel key, the CPU-B 58 of the child device B200 instructs a display control (video signal process) for a message “BATTERY CHARGE REMAINDER SMALL. VIEWING PROGRAM WILL BE TRUNCATED” to the OSD processor B46, thereby displaying such message on the display B47 (step S144), thus informing the user of the termination of viewing. The CPU-A 38 of the parent device A100 executes a wireless transmission of parent device status information indicating termination of the transmission to the child device B200 (step 146) and terminates the transmission of the transport stream data to the child device B200 (step S146).

In the present embodiment, as explained in the foregoing, while the user views a digital broadcasting in the child device B200 utilizing the digital tuner B12 of the parent device A100, the CPU-B 58 of the child device B200 watches the battery remainder charge in the child device B200, and, in case the battery remainder charge becomes equal to or less than a threshold value and the other digital tuner A2 of the parent device A100 is not in use, the CPU-A 38 of the parent device A100 terminates the transmission of the transport stream data to the child device B200 and sets the digital tuner A2, the video decoder A6 and the audio decoder A7 in a state capable of viewing the broadcast program in the parent device A100, whereby the user can automatically view, in continuation in the parent device A100, the broadcast program that has been viewed in the child device B200.

### Third Embodiment

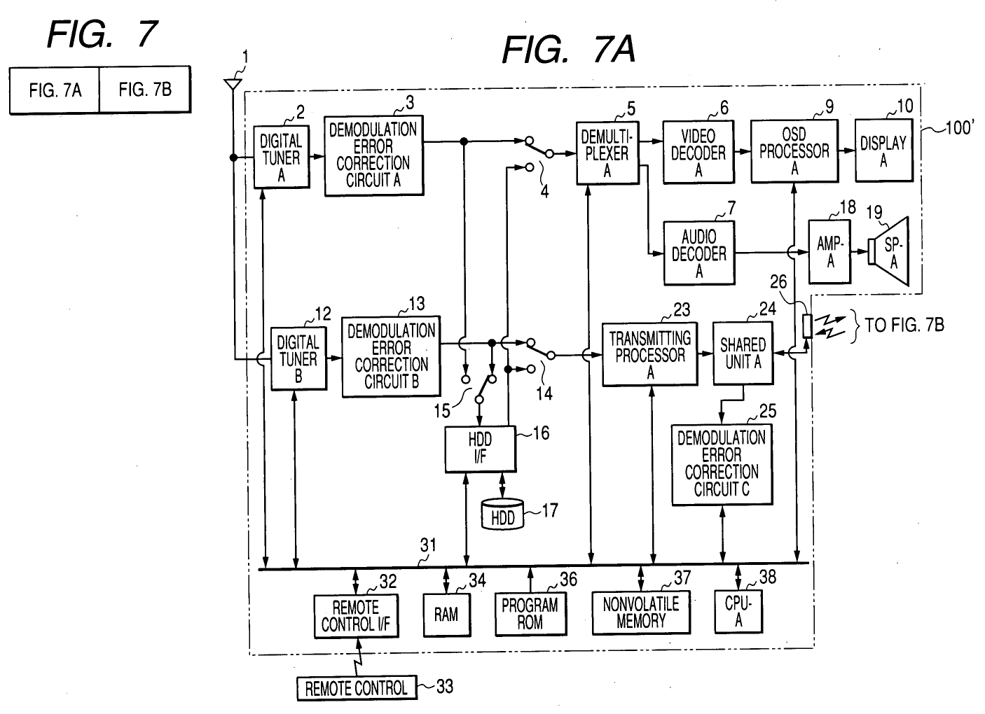

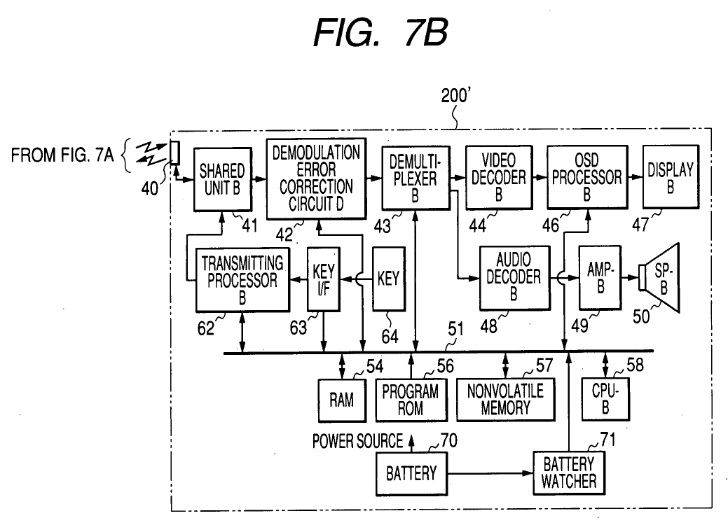

FIGS. 7A and 7B are block diagrams showing a configuration of a parent/child television system constituting a third embodiment of the present invention.

The present embodiment is different from the foregoing first embodiment in that the parent device A100′ is provided with switches 4, 14, 15, a hard disk drive (HDD) interface 16 and a HDD 17, and the child device B200 is provided with a battery 70 and battery watching means 71 (watching means). Other components of the present embodiment are similar to those in the first embodiment (FIG. 1), thus represented by corresponding numbers and are not explained further.

At first, there will be explained differences of the present embodiment from the first embodiment, with reference to FIGS. 7A and 7B. The HDD 17 of the parent device A100 is used for recording and play the transport stream data received in the parent device A100′. The HDD interface 16 controls the HDD 17 according to an instruction from the CPU-A 38. The HDD may also be replaced by another large capacity memory enabling a high speed access such as MO, DVD-RAM or DVD-RW.

A switch 15 switches a data input to the HDD interface 16, thereby selecting the broadcast transport data stream either from the demodulation/error correction circuit A3 or from the demodulation/error correction circuit B13. Thus the HDD 17 can record the transport data stream selected by the demodulation/error correction circuit A3 or by the demodulation/error correction circuit B13. The HDD 16 is capable of simultaneous recording and reproduction for one channel each. This enables so-called time-shift reproduction, by executing a recording and a reproduction simultaneously on a same broadcast program.

A switch 4 is provided between the demodulation/error correction circuit A3 and the demultiplexer A5, thereby selecting the broadcast transport data stream either from the demodulation/error correction circuit A3 or from the HDD interface 16 as the input to the demultiplexer A5. Thus the display A10 and the speaker A19 can reproduce, in addition to the broadcast transport stream data from the digital tuner A2, a broadcast transport stream data stored in the HDD 17. At the reception of a digital broadcasting, the switch 4 is connected at the side of the the demodulation/error correction circuit A3.

A switch 14 is provided between the demodulation/error correction circuit B13 and the transmission processor A23, thereby selecting the broadcast transport data stream either from the demodulation/error correction circuit B13 or from the HDD interface 16 as the input to the transmission processor A23. Thus the child device B200′ can reproduce, in addition to the broadcast transport stream data from the digital tuner B12, a broadcast transport stream data stored in the HDD 17. At the reception of a digital broadcasting, the switch 14 is connected at the side of the the demodulation/error correction circuit B13.

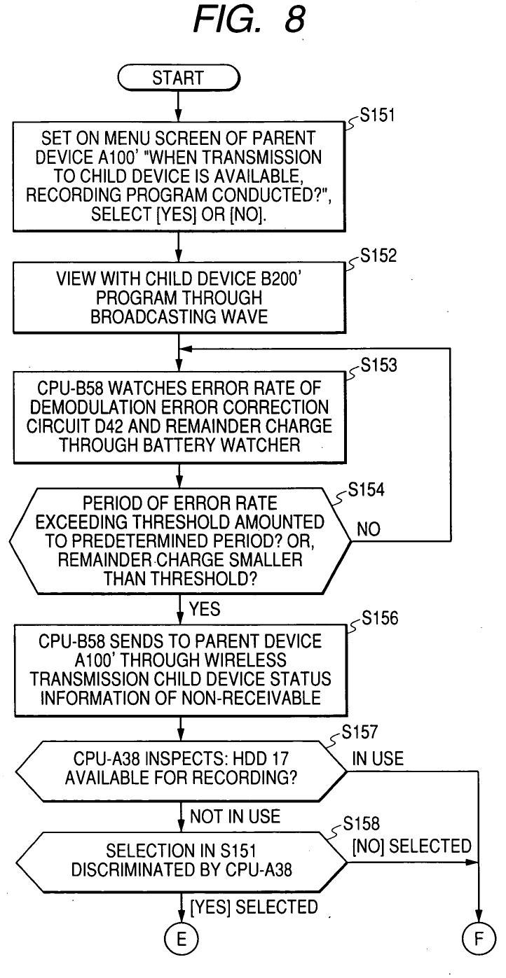

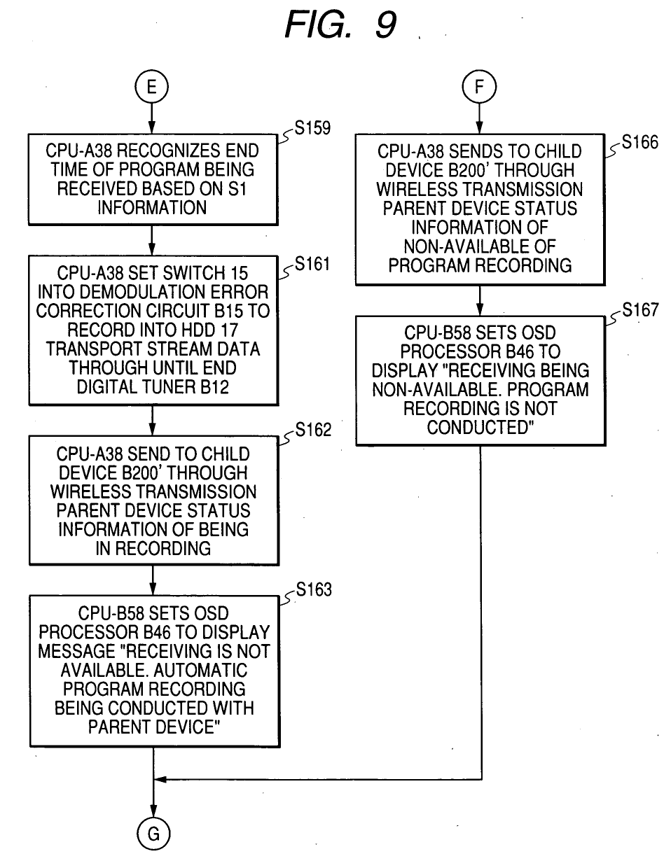

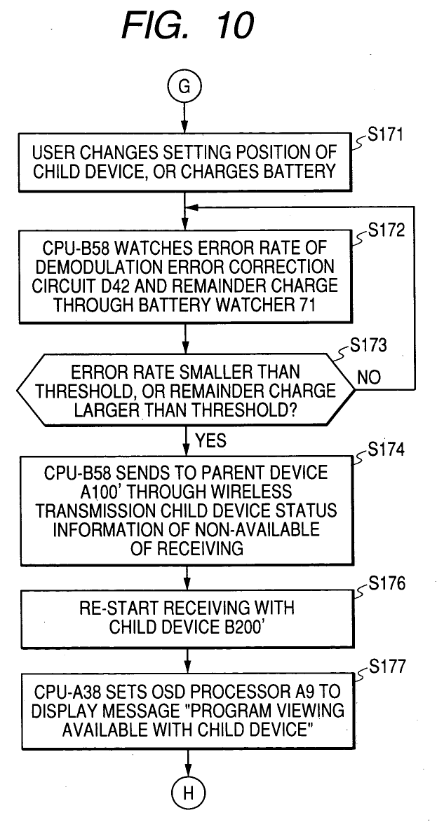

The CPU-A 38 of the parent device A100′ executes a process of a parent device side according to a program, in the flow charts shown in FIG. 8 to 12, and the CPU-B 58 of the child device B200′ executes a process of a child device side according to a program, in the flow charts shown in FIG. 8 to 12.

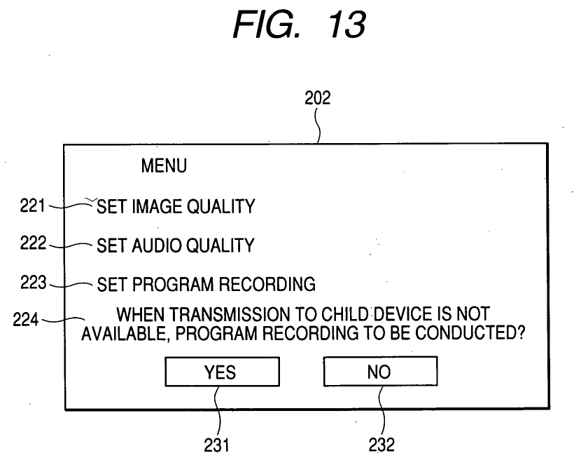

FIG. 13 is a view showing an example of a menu image prepared by the OSD processor A9 of the parent device A100.

FIG. 13 shows an image 202 displayed on the display A10, with messages “SET IMAGE QUALITY”, “SET AUDIO QUALITY” and “SET PROGRAM RECORDING” 221-223, “WHEN TRANSMISSION TO CHILD DEVICE IS NOT AVAILABLE, PROGRAM RECORDING TO BE CONDUCTED” 224, “YES (recording)” 231, and “NO (no recording)” 232.

In the following there will be explained, with reference to flow charts shown in FIGS. 5 and 6 and a menu image shown in FIG. 13, operations when the reception state becomes worse or a remainder charge of the battery becomes low while the user enjoys, in the parent/child television system of the present embodiment, a digital broadcasting in the child device B200 by receiving transport stream data utilizing the digital tuner B12 of the parent device A100.

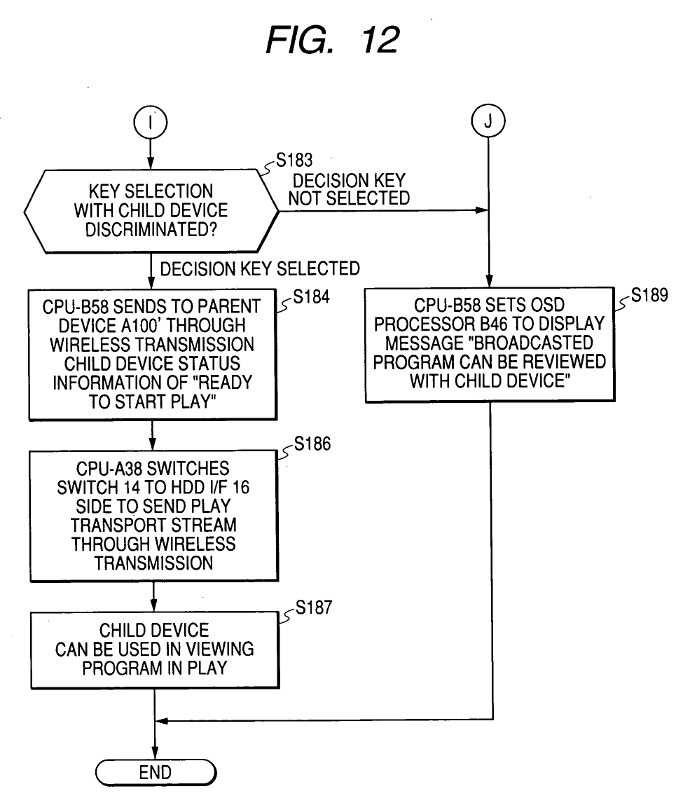

Referring to FIGS. 8 and 12, it is assumed that the user depresses, utilizing a cursor key (not shown) of the remote control 33, the “YES (recording)” key 231 or the “NO (no recording)” key 232 and then the decision key (not shown). Key codes corresponding to these key operations are recognized by the CPU-A 38 of the parent device A100′, which thus executes a setting of the user operation (step S151).

After the setting, the user views a digital broadcast wave with the child device B200′ (step S152). In this state, the CPU-B 58 of the child device B200′ watches an error rate of the transport stream data measured by the demodulation/error correction circuit D42 and a battery remainder charge watched by a battery watching unit 71 (step S153).

The CPU-B 58 of the child device B200′ discriminates whether a state of the error rate exceeding a threshold value has reached a predetermined time or the battery remainder charge is less than a threshold value (step S154), and, in case the state of the error rate exceeding the threshold value has reached a predetermined time or the battery remainder charge is less than the threshold value (reception incapable state), the sequence proceeds to a step S156 but the sequence otherwise returns to the step S153.

In case of a reception incapable state, the CPU-B 58 of the child device B200′, by a wireless transmission, transmits child device status information indicating a reception incapable state to the parent device A100′ (step S156). Then, the CPU-A 38 of the parent device A100′ gives up the viewing by the user on the child device B200′ and executes a preparation for program recording in the parent device A100′. The CPU-A 38 of the parent device A100′ checks a use state whether a recording by the digital tuner A2 is currently executed on the HDD 17 (step S157), and, in case the digital tuner A2 is currently in use and the recording on the HDD 17 is not possible, the sequence proceeds to a step S166, but, in case the digital tuner A2 is not in use and the recording on the HDD 17 is possible, the sequence proceeds to a step S158.

In case the digital tuner A2 is not in use and the recording on the HDD 17 is possible, the CPU-A 38 of the parent device A100′ discriminates the setting in the aforementioned step S151 (step S158), and sequence proceeds to a step s159 in case of a setting “YES (recording)” or to a step s166 in case of a setting “NO (no recording)”.

In case of a setting “YES (recording)”, the CPU-A 38 of the parent device A100′ recognizes, by the SI information, an end time of the currently received broadcast program (step S159). For recording, the CPU-A 38 of the parent device A100′ shifts the switch 15 to the demodulation/error correction circuit B13, and records the transport stream data of the digital tuner B12 on the HDD 17 until the end time obtained in the process of the step S159 (step S161). The CPU-A 38 of the parent device A100′ executes a wireless transmission of parent device status information indicating that the recording is in progress, to the child device B200′ (step S162).

In response, the CPU-B 58 of the child device B200′ instructs a display control (video signal process) for a message “RECEIVING IS NOT AVAILABLE. AUTOMATIC PROGRAM RECORDING BEING CONDUCTED WITH PARENT DEVICE” to the OSD processor B46, thereby displaying such message on the display B47 (step S163), thus informing the user that the viewing of the digital broadcasting is not possible but it is recorded in the parent device A100′. Thereafter the user can view a broadcast program which is interrupted during the viewing on the child device B200′ and is being recorded, or a recorded broadcast program.

On the other hand, in case of a setting “NO (no recording)”, the CPU-A 38 of the parent device A100′ executes a wireless transmission of parent device status information indicating that the recording is not executed, to the child device B200′ (step S166). In response, the CPU-B 58 of the child device B200′ instructs a display control (video signal process) for a message “RECEIVING BEING NON-AVAILABLE. PROGRAM RECORDING IS NOT CONDUCTED” to the OSD processor B46, thereby displaying such message on the display B47 (step S167), thus informing the user that the viewing of the digital broadcasting is not possible nor it is recorded in the parent device A100′.

The foregoing is a process executed when the child device B200′ becomes incapable of the reception. In the following there will be explained a process when the child device B200′ becomes capable of the reception again.

The user may resolve the cause for disabled reception, for example by changing the location of the child device B200′ or by charging the battery 70 of the child device B200′ (step S171). The CPU-B 58 of the child device B200′ watches an error rate of the transport stream data measured by the demodulation/error correction circuit D42 and a battery remainder charge watched by a battery watching unit 71 (step S172).

The CPU-B 58 of the child device B200′ discriminates whether the error rate does not exceed the threshold value and the battery remainder charge is larger than the threshold value (step S173), and, in case the error rate does not exceed the threshold value and the battery remainder charge is larger than the threshold value (reception capable state), the sequence proceeds to a step S174 but otherwise (reception incapable state) the sequence returns to the step S172.

In case a reception capable state is reached, the CPU-B 58 of the child device B200′, by a wireless transmission, transmits child device status information indicating a reception capable state to the parent device A100′ (step S174), and restarts the reception of the transport stream data in the child device. B200′ (step S176). Then, the CPU-A 38 of the parent device A100′ instructs a display control (video signal process) for a message “PROGRAM VIEWING AVAILABLE WITH CHILD DEVICE” to the OSD processor A9, thereby displaying such message on the display A10 (step S177), thus informing the user who might have given up the viewing on the child device B200′ and might be viewing on the parent device A100′ that the viewing on the child device B200′ is available again.

Then the CPU-A 38 of the parent device A100′ discriminates whether the broadcast program which was interrupted during the viewing by the user on the child device B200′ is being recorded or has been recorded (step S178), and, the sequence proceeds to a step S179 in case the broadcast program which was interrupted during the viewing by the user on the child device B200′ is being recorded or has been recorded, but the sequence proceeds to a step S88 in case the broadcast program which was interrupted during the viewing by the user on the child device B200′ is not being recorded nor has been recorded.

In case the broadcast program interrupted during the viewing is being recorded or has been recorded, the CPU-A 38 of the parent device A100′ checks whether the HDD 17 is not used by the demultiplexer A5 and is available for reproduction (step S179). Then the sequence proceeds to a step S181 in case the HDD 17 is not used by the demultiplexer A5 and is available for reproduction but to a step S188 in case the HDD 17 is used by the demultiplexer A5 and is not available for reproduction.

In case the the HDD 17 is not used by the demultiplexer A5 and is available for reproduction, the CPU-A 38 of the parent device A100′ executes a wireless transmission of parent device status information indicating that the reproduction is possible, to the child device B200′ (step S181). In response, the CPU-B 58 of the child device B200′ instructs a display control (video signal process) for a message “PLAY FROM INTERRUPTED POSITION WITH CHILD DEVICE. SELECT DECISION KEY TO START PLAY” to the OSD processor B46, thereby displaying such message on the display B47 (step S182), thus informing the user of a viewing capable state where the viewing in the child device is reopened and the interrupted and recorded broadcast program can be reproduced by a depression of the decision key of the child device B200′.

Then the CPU-B 58 of the child device B200′ discriminates a key input by the user on the child device B200′ (step S183), and the sequence proceeds to a step S184 in case of a depression of the decision key indicating a start of reproduction in the child device B200′, or to a step S189 in case the decision key is not depressed, where the reproduction is not executed since the user wishes to continue current viewing of a broadcast program or does not wish the reproduction.

In case the decision key is depressed, the CPU-B 58 of the child device B200′ executes a wireless transmission of child device status information indicating a completion of preparation for reproduction to the parent device A100′. In response, the CPU-A 38 of the parent device A100′ shifts the switch 14 to the HDD 16, thereby transmitting a reproduced transport stream data to the child device B200′ (step S186). Thus the user can view the reproduced broadcast program on the child device B200′ (step S187).

On the other hand, in case the broadcast program interrupted during the viewing is not being recorded nor has been recorded, the CPU-A 38 of the child device A100′ executes a wireless transmission of parent device status information indicating that the reproduction is not possible to the child device B200′ (step S188). In response, the CPU-B 58 of the child device B200′ instructs a display control (video signal process) for a message “BROADCASTED PROGRAM CAN BE REVIEWED WITH CHILD DEVICE” to the OSD processor B46, thereby displaying such message on the display B47 (step S189), thus informing the user that the viewing of the digital broadcasting is possible in the child device B200′.

In the present embodiment, as explained in the foregoing, while the user views a digital broadcasting in the child device B200 utilizing the digital tuner B12 of the parent device A100, the CPU-B 58 of the child device B200′ watches the reception state of the child device B200′ and the battery remainder charge in the child device B200′, and, in case the reception state becomes worse or the battery remainder charge becomes equal to or less than a threshold value and the other digital tuner A2 of the parent device A100′ is not in use and available for recording, the CPU-A 38 of the parent device A100′ starts a recording on the HDD 17, whereby the user can automatically record, in the parent device B200′, the broadcast program that has been viewed in the child device B200′.

Also it is possible not to record a broadcast program not worth recording by rendering the remote control 33 capable of selecting whether or not to execute an automatic recording. Also in case the child device B200′ re-starts reception from the patent device A100′ and if the HDD 17 of the patent device A100′ is available for reproduction, the user can view a continuation of the broadcast program, that has been interrupted, in the child device B200′ by reproduction.

### Fourth Embodiment

The present embodiment is different from the foregoing third embodiment in that the parent device A100′ discriminates a reception capable state of the child device B200′ by receiving therefrom a periodical status. Other components of the present embodiment are similar to those in the first embodiment (FIG. 1), thus represented by corresponding numbers and are not explained further.

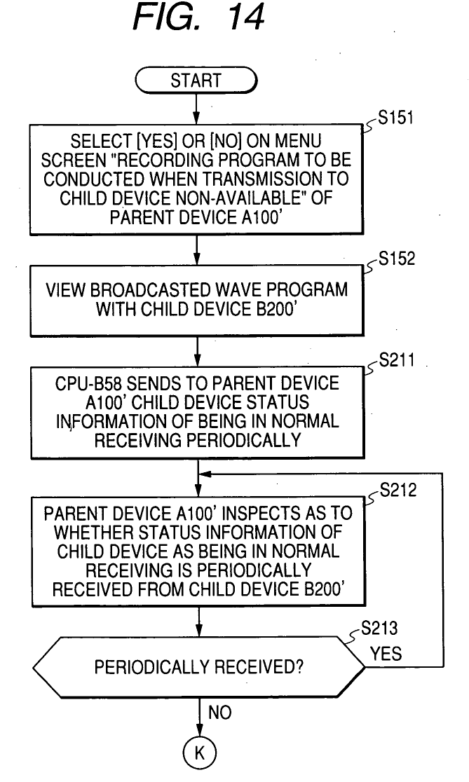

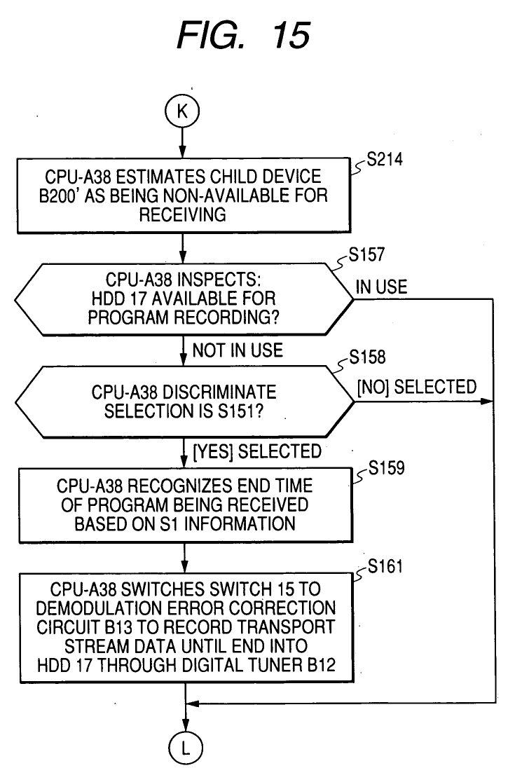

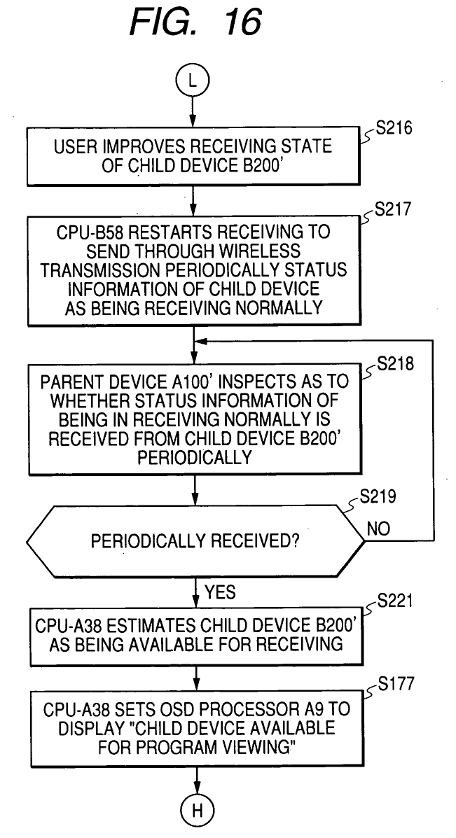

The CPU-A 38 (control means) of the parent device A100′ executes a process of a parent device side according to a program, in the flow charts shown in FIG. 14 to 16, and the CPU-B 58 (informing means) of the child device B200′ executes a process of a child device side according to a program, in the flow charts shown in FIG. 14 to 16.

In the following there will be explained, with reference to flow charts shown in FIGS. 14 to 16 and a menu image shown in FIG. 13, differences from the third embodiment in the operations of the parent/child television system of the present invention.

Referring to FIGS. 14 to 16, the user sets [YES] or [NO] in a message “WHEN TRANSMISSION TO CHILD DEVICE IS NOT AVAILABLE, PROGRAM RECORDING TO BE CONDUCTED?” on the menu image of the parent device A100′ shown in FIG. 13 (step S151). After the setting, the user views a digital broadcasting with the child device B200′ (step S152). In this state, the CPU-B 58 of the child device B200′ executes a wireless transmission, to the parent device A100′, of child device status information indicating a normal reception periodically at a time interval, for example a vertical synchronization cycle (S211).

The CPU-A 38 of the patent device A100′ discriminates whether the child device status information indicating the normal reception is periodically received from the child device B200′ (step S212). In case the child device status information indicating the normal reception is periodically received, the sequence returns to the step S211 and the CPU-A 38 of the patent device A100′ continues reception. In case a failure in the reception of the child device status information indicating the normal reception occurs a certain number of times, the CPU-A 38 of the patent device A100′ judges that the child device B200′ is incapable of reception (step S214), thus giving up the viewing by the user in the child device B200′ and executes a preparation for recording in the parent device A100′.

The CPU-A 38 of the parent device A100′ checks a use state whether a recording by the digital tuner A2 is currently executed on the HDD 17 (step S157), and, in case the digital tuner A2 is currently in use and the recording is not possible, the sequence proceeds to a step S216, but, in case the digital tuner A2 is not in use and the recording is possible, the sequence proceeds to a step S158.

In case the digital tuner A2 is not in use and the recording is possible, the CPU-A 38 of the parent device A100′ discriminates the setting in the aforementioned step S151 (step S158), and sequence proceeds to a step S159 in case of a setting “YES (recording)” or to a step S216 in case of a setting “NO (no recording)”.

In case of a setting “YES (recording)”, the CPU-A 38 of the parent device A100′ recognizes, by the SI information, an end time of the currently received broadcast program (step S159). For recording, the CPU-A 38 of the parent device A100′ shifts the switch 15 to the demodulation/error correction circuit B13, and records the transport stream data of the digital tuner B12 on the HDD 17 until the end time obtained in the process of the step S159 (step S161).

The foregoing is a process executed when the child device B200′ becomes incapable of the reception. In the following there will be explained a process when the child device B200′ becomes capable of the reception again.

The user may resolve the cause for disabled reception, for example by changing the location of the child device B200′ or by charging the battery 70 of the child device B200′ thereby improving the reception state of the child device B200′ (step S216). The CPU-B 58 of the child device B200′, upon re-starting the reception from the parent device A100′, periodically transmits child device status information indicating a normal reception to the parent device A100′ (step S217).

The CPU-A 38 of the patent device A100′ discriminates-whether the child device status information indicating the normal reception is periodically received from the child device B200′ (step S218). In case the child device status information indicating the normal reception is not periodically received, the sequence returns to the step S218 and the CPU-A 38 of the patent device A100′ continues reception. In case the child device status information indicating the normal reception can be received, the sequence proceeds to a step S221.

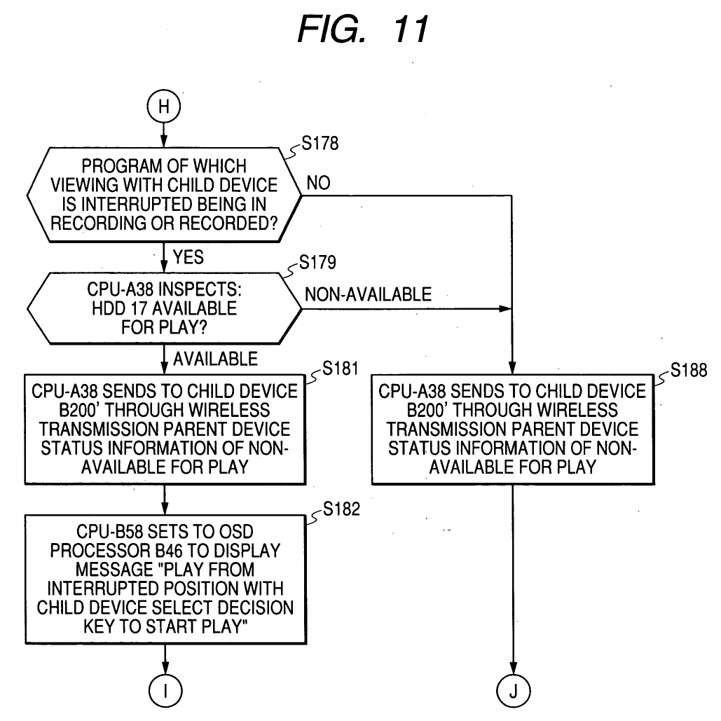

The CPU-A 38 of the parent device A100′, judging that the child device B200′ is capable of reception (step S221), instructs a display control (video signal process) for a message “PROGRAM VIEWING AVAILABLE WITH CHILD DEVICE” to the OSD processor A9, thereby displaying such message on the display A10 (step S177). The process thereafter is same as the process after the step S178 of the third embodiment shown in FIG. 11, and will not therefore be explained.

In the present embodiment, as explained in the foregoing, even in case the child device B200′ suddenly becomes incapable of receiving the video stream data from the patent device A100′ and does not have an enough time for sending the status indicating a reception incapable state to the patent device A100′, the CPU-A 38 of the child device A100′ recognizes a reception incapable state of the child device B200′ when the status indicating the normal reception, periodically transmitted from the child device B200′ to the parent device A100′, is not transmitted from the child device B200′, and starts the preparation for recording in the parent device A100′, whereby the automatic recording is rendered possible in the parent device A100′.

### Other Embodiments

The foregoing first embodiment has shown a case where the broadcast program that has been displayed in the child device is displayed in the parent device when the reception state of the child device becomes worse, but such configuration is not restrictive and the user may be allowed to select either to display the broadcast program, that has been displayed in the child device, in the parent device, or to record the broadcast program, that has been displayed in the child device, in the parent device.

The foregoing second embodiment has shown a case where the broadcast program that has been displayed in the child device is displayed in the parent device when the remainder charge of the battery of the child device becomes equal to or less than the threshold value, but such configuration is not restrictive and the user may be allowed to select either to display the broadcast program, that has been displayed in the child device, in the parent device, or to record the broadcast program, that has been displayed in the child device, in the parent device.

The foregoing third embodiment has shown a case where the broadcast program that has been displayed in the child device is recorded in the parent device when the reception state of the child device becomes worse or the remainder charge of the battery of the child device becomes equal to or less than the threshold value, but such configuration is not restrictive and the user may be allowed to select either to record the broadcast program, that has been displayed in the child device, in the parent device, or to display the broadcast program, that has been displayed in the child device, in the parent device.

The foregoing fourth embodiment has shown a case where the broadcast program that has been displayed in the child device is recorded in the parent device when the status information indicating the normal reception is not transmitted from the child device to the parent device, but such configuration is not restrictive and the user may be allowed to select either to record the broadcast program, that has been displayed in the child device, in the parent device, or to display the broadcast program, that has been displayed in the child device, in the parent device.

The foregoing first to fourth embodiments have shown a case where the parent device and the child device execute wireless communication, but such configuration is not restrictive and the parent device and the child device may execute wired communication.

The present invention can also be realized by supplying a computer or a CPU with a program (corresponding to flow charts shown in FIGS. 2 to 3, 5 to 6, 8 to 12, and 14 to 16) of a software realizing the functions of the aforementioned embodiments and reading and executing such supplied program by the computer or the CPU.

In such case, the program may be supplied directly from a recording medium storing such program, or supplied by a downloading from another unillustrated computer or a database connected to the internet, a commercial network- or a local area network.

The program may assume a form of object codes, program codes executed by an interpreter, or script data to be supplied to an OS (operating system).

Also the present invention can be realized by supplying a computer or a CPU with a program of a software realizing the functions of the aforementioned embodiments and reading and executing such supplied program by the computer or the CPU.

In such case, the program codes themselves read from the memory medium realize the functions of the aforementioned embodiments, and the memory medium storing the program codes constitutes the present invention.

The memory medium storing the program codes can be, for example, a ROM, a RAM, an NV-RAM, a floppy disk (trade name), a hard disk, an optical disk (trade name), a magnetooptical disk, a CD-ROM, an MO, a CD-R, a CD-RW, a DVD-ROM, a DVD-RAM, a DVD-RW, a DVD+RW, a magnetic tape or a non-volatile memory card.

The functions of the aforementioned embodiments can be realized, not only in a case of executing the read program codes by the computer, but also in a case where an OS or the like functioning on the computer executes all the actual processes or a part thereof under the instruction of the program codes.

This application claims priority from Japanese Patent Application No. 2003-410610 filed on Dec. 9, 2003, which is hereby incorporated by reference herein.

1. A broadcast receiving apparatus including a parent device capable of receiving a broadcast wave and displaying a broadcast program and a child device constructed communicably with said parent device and capable of displaying a broadcast program based on broadcast data transmitted from said parent device:
wherein said child device comprises watching means which watches a reception status of said broadcast data; and
said parent device comprises control means which, based on a judgment of said watching means, enables said parent device to display the broadcast program that has been displayed on said child device.

2. A broadcast receiving apparatus according to claim 1, wherein said control means of said parent device, upon receiving a notice for a worsened state of the reception status from said child device based on the judgment of said watching means, terminates the transmission of said broadcast data to said child device and enables said parent device to display the broadcast program that has been displayed on said child device.

3. A broadcast receiving apparatus including a parent device capable of receiving a broadcast wave and displaying a broadcast program and a child device constructed communicably with said parent device and capable of displaying a broadcast program based on broadcast data transmitted from said parent device:
wherein said child device comprises watching means which watches a remainder charge of a battery for driving said child device; and
said parent device comprises control means which, based on a judgment of said watching means, enables said parent device to display the broadcast program that has been displayed on said child device.

4. A broadcast receiving apparatus according to claim 3, wherein said control means of said parent device, upon receiving a notice from the child device for a remainder charge of the battery equal to or less than a set value, terminates the transmission of said broadcast data to said child device and enables said parent device to display the broadcast program that has been displayed on said child device.

5. A broadcast receiving apparatus including a parent device capable of receiving a broadcast wave and displaying a broadcast program and a child device constructed communicably with said parent device and capable of displaying a broadcast program based on broadcast data transmitted from said parent device:
wherein said child device comprises watching means which watches a reception status of said child device and/or a remainder charge of a battery for driving said child device; and
said parent device comprises control means which, based on a judgment of said watching means, causes said parent device to record the broadcast program that has been displayed on said child device.

6. A broadcast receiving apparatus according to claim 5, wherein said control means of said parent device, upon receiving a notice from the child device for a worsened state of the reception status or for a remainder charge of the battery equal to or less than a set value based on the judgment of said watching means, records, in said parent device, the broadcast program that has been displayed on said child device.

7. A broadcast receiving apparatus according to claim 5, wherein said control means of said parent device, upon receiving a notice from the child device that a worsened state of the reception status or a remainder charge of the battery equal to or less than a set value is resolved, based on the judgment of said watching means, informs said child device of a fact that the broadcast program recorded in said parent device can be reproduced in said child device.

8. A broadcast receiving apparatus including a parent device capable of receiving a broadcast wave and displaying a broadcast program and a child device constructed communicably with said parent device and capable of displaying a broadcast program based on broadcast data transmitted from said parent device:
wherein said child device comprises informing means which periodically transmits status information to said patent device; and
said parent device comprises control means which, in case said status information is not transmitted from said child device, records, in said parent device, the broadcast program that has been displayed on said child device.

9. A broadcast receiving apparatus according to claim 8, wherein said control means of said parent device, when said status information is transmitted again from said child device, informs said child device of a fact that the broadcast program recorded in said parent device can be reproduced in said child device.

10. A broadcast receiving apparatus according to claim 5, wherein said child device is capable of wireless communication with said parent device and is portable.

11. A control method for a broadcast receiving apparatus including a parent device capable of receiving a broadcast wave and displaying a broadcast program and a child device constructed communicably with said parent device and capable of displaying a broadcast program based on broadcast data transmitted from said parent device, the method comprising steps of:
watching a reception status of said broadcast data; and
when said parent device receives a notice for a worsened state of the reception status from said child device, enabling said parent device to display the broadcast program that has been displayed on said child device.

12. A control method for a broadcast receiving apparatus including a parent device capable of receiving a broadcast wave and displaying a broadcast program and a child device constructed communicably with said parent device and capable of displaying a broadcast program based on broadcast data transmitted from said parent device, the method comprising steps of:
watching a remainder charge of a battery for driving said child device; and
when said parent device receives a notice for a remainder charge of the battery equal to or less than a set value, enabling said parent device to display the broadcast program that has been displayed on said child device.

13. A control method for a broadcast receiving apparatus including a parent device capable of receiving a broadcast wave and displaying a broadcast program and a child device constructed communicably with said parent device and capable of displaying a broadcast program based on broadcast data transmitted from said parent device, the method comprising steps of:
watching a reception status of said child device and/or a remainder charge of a battery for driving said child device; and
when said parent device receives a notice from the child device for a worsened state of the reception status or for a remainder charge of the battery equal to or less than a set value, recording, in said parent device, the broadcast program that has been displayed on said child device.

14. A control method for a broadcast receiving apparatus including a parent device capable of receiving a broadcast wave and displaying a broadcast program and a child device constructed communicably with said parent device and capable of displaying a broadcast program based on broadcast data transmitted from said parent device, the method comprising steps of:
periodically transmitting status information from said child device to said patent device; and
when said status information is not transmitted from said child device to said parent device, recording, in said parent device, the broadcast program that has been displayed on said child device.

15. A program for causing a computer to execute a control method for a broadcast receiving apparatus including a parent device capable of receiving a broadcast wave and displaying a broadcast program and a child device constructed communicably with said parent device and capable of displaying a broadcast program based on broadcast data transmitted from said parent device, the method comprising steps of:
watching a reception status of said broadcast data; and
when said parent device receives a notice for a worsened state of the reception status from said child device, enabling said parent device to display the broadcast program that has been displayed on said child device.

16. A program for causing a computer to execute a control method for a broadcast receiving apparatus including a parent device capable of receiving a broadcast wave and displaying a broadcast program and a child device constructed communicably with said parent device and capable of displaying a broadcast program based on broadcast data transmitted from said parent device, the method comprising steps of:
watching a remainder charge of a battery for driving said child device; and
when said parent device receives a notice for a remainder charge of the battery equal to or less than a set value, enabling said parent device to display the broadcast program that has been displayed on said child device.

17. A program for causing a computer to execute a control method for a broadcast receiving apparatus including a parent device capable of receiving a broadcast wave and displaying a broadcast program and a child device constructed communicably with said parent device and capable of displaying a broadcast program based on broadcast data transmitted from said parent device, the method comprising steps of:
watching a reception status of said child device and/or a remainder charge of a battery for driving said child device; and
when said parent device receives a notice from the child device for a worsened state of the reception status or for a remainder charge of the battery equal to or less than a set value, recording, in said parent device, the broadcast program that has been displayed on said child device.

18. A program for causing a computer to execute a control method for a broadcast receiving apparatus including a parent device capable of receiving a broadcast wave and displaying a broadcast program and a child device constructed communicably with said parent device and capable of displaying a broadcast program based on broadcast data transmitted from said parent device, the method comprising steps of:
periodically transmitting status information from said child device to said patent device; and
when said status information is not transmitted from said child device to said parent device, recording, in said parent device, the broadcast program that has been displayed on said child device.
